(19) United States
(12) Patent Application Publication
(10) Pub. No.: US 2024/0222793 A1
(43) Pub. Date: Jul. 4, 2024

(54) LDH SEPARATOR, MANUFACTURING METHOD THEREFOR, AND RECHARGEABLE ZINC BATTERY

(71) Applicant: NGK INSULATORS, LTD., Nagoya-City (JP)

(72) Inventors: Shumpei ONO, Nagoya-City (JP); Naoko INUKAI, Nagoya-City (JP); Shohei YOKOYAMA, Nagoya-City (JP)

(21) Appl. No.: 18/604,631

(22) Filed: Mar. 14, 2024

Related U.S. Application Data
(63) Continuation of application No. PCT/JP2022/022633, filed on Jun. 3, 2022.

(30) Foreign Application Priority Data
Oct. 6, 2021 (JP) 2021-164883

(51) Int. Cl. H01M 50/449; H01M 8/083; H01M 10/30; H01M 50/403; H01M 50/411; H01M 50/434; H01M 50/491; H01M 50/497

(52) U.S. Cl. CPC H01M 50/449; H01M 8/083; H01M 10/30; H01M 50/403; H01M 50/411; H01M 50/434; H01M 50/491; H01M 50/497

(57) ABSTRACT

There is provided an LDH separator including: a porous substrate; and a surface layer provided on at least one surface of the porous substrate and including a hydroxide ion-conductive layered compound that is a layered double hydroxide (LDH) and/or a layered double hydroxide (LDH)-like compound. The LDH separator has an ionic conductivity of 1.0 mS/cm or more, and an adhesion force of 5.0 mN or more between the surface layer and the porous substrate. The adhesion force is the critical load value measured by subjecting a surface including the surface layer of the LDH separator to a micro-scratch test in accordance with JIS R3255-1997 under the conditions of a scratch rate of 10 μm/s, a tip curvature radius of a diamond indenter needle of 25 μm, a load application rate of 30 mN/min, an excitation amplitude of 50 μm, and an excitation frequency of 45 Hz.

### CROSS-REFERENCE TO RELATED APPLICATIONS

This application is a continuation application of PCT/JP2022/022633 filed Jun. 3, 2022, which claims priority to Japanese Patent Application No. 2021-164883 filed Oct. 6, 2021, the entire contents all of which are incorporated herein by reference.

### BACKGROUND OF THE INVENTION

### 1. Field of the Invention

The present inventions relate to an LDH separator and a method for producing the LDH separator, and a zinc secondary battery.

### 2. Description of the Related Art

In zinc secondary batteries such as nickel-zinc secondary batteries and air-zinc secondary batteries, metallic zinc precipitates from a negative electrode in the form of dendrites upon charge, and penetrates into voids of a separator such as a nonwoven fabric and reaches a positive electrode, which is known to result in bringing about short-circuiting. The short circuit due to such zinc dendrites shortens a life in repeated charge/discharge conditions.

In order to deal with the above issues, batteries including layered double hydroxide (LDH) separators that prevent penetration of zinc dendrites while selectively permeating hydroxide ions, have been proposed. For example, Patent Literature 1 (WO2013/118561) discloses that an LDH separator is provided between a positive electrode and a negative electrode in a nickel-zinc secondary battery. Moreover, Patent Literature 2 (WO2016/076047) discloses a separator structure including an LDH separator fitted or joined to a resin outer frame, and discloses that the LDH separator has a high denseness to the degree that it has a gas impermeability and/or a water impermeability. Moreover, this literature also discloses that the LDH separator can be composited with porous substrate. Moreover, Patent Literature 3 (WO2016/067884) discloses various methods for forming an LDH dense membrane on a surface of a porous substrate to obtain a composite material. This method comprises steps of uniformly adhering a starting material that can impart a starting point for LDH crystal growth to a porous substrate and subjecting the porous substrate to hydrothermal treatment in an aqueous solution of raw materials to form an LDH dense membrane on the surface of the porous substrate. An LDH separator that achieved further densification by roll-pressing an LDH/porous substrate composite made via hydrothermal treatment, has also been proposed. For example, Patent Literature 4 (WO2019/124270) discloses an LDH separator that includes a polymer porous substrate and an LDH filling up the porous substrate and has a linear transmittance at a wavelength of 1,000 nm of 1% or more.

An LDH-like compound has also been known as a hydroxide and/or an oxide with a layered crystal structure, which may not be called an LDH but is analogous to LDH, and exhibits hydroxide-ion conductive properties similar to such an extent that it can be collectively referred to as a hydroxide ion-conductive layered compound, together with LDH. For example, Patent Literature 5 (WO2020/255856) discloses a hydroxide ion-conductive separator that includes a porous substrate and a layered double hydroxide (LDH)-like compound that fills up pores of the porous substrate, wherein this LDH-like compound is a hydroxide and/or an oxide with a layered crystal structure including Mg and at least one element including Ti selected from the group consisting of Ti, Y, and Al. This hydroxide ion-conductive separator is said to have more excellent alkali resistance than conventional LDH separators, thereby making it possible to inhibit short circuits due to zinc dendrites further effectively.

### CITATION LIST

### Patent Literature

Patent Literature 1: WO2013/118561
Patent Literature 2: WO2016/076047
Patent Literature 3: WO2016/067884
Patent Literature 4: WO2019/124270
Patent Literature 5: WO2020/255856

### SUMMARY OF THE INVENTION

When using each LDH separator as disclosed in Patent Literatures 1 to 5 to constitute a zinc secondary battery such as a nickel-zinc battery, a short circuit and the like due to zinc dendrites can be prevented to some extent. However, further improvement in cycle characteristics (particularly dendrite derived short-circuit prevention characteristics when a charge/discharge cycle is repeated) is desired.

The present inventors have recently found that an LDH separator comprising a porous substrate and a surface layer provided on the surface thereof, in which the LDH separator has an ionic conductivity of 1.0 mS/cm or more and an adhesion force between the surface layer and the porous substrate is 5.0 mN or more can achieve a further improvement in cycle characteristics of a battery comprising this separator.

Thus, an object of the present invention is to provide an LDH separator capable of further improving the cycle characteristics of a battery.

The present invention provides the following aspects:

### [Aspect 1]

An LDH separator comprising:
a porous substrate; and
a surface layer provided on at least one surface of the porous substrate and comprising a hydroxide ion-conductive layered compound that is a layered double hydroxide (LDH) and/or a layered double hydroxide (LDH)-like compound;
wherein the LDH separator has an ionic conductivity of 1.0 mS/cm or more, and an adhesion force of 5.0 mN or more between the surface layer and the porous substrate, and
the adhesion force is a critical load value measured by subjecting a surface including the surface layer of the LDH separator to a micro-scratch test in accordance with JIS R3255-1997 under the conditions of a scratch rate of 10 μm/s, a tip curvature radius of a diamond indenter needle of 25 μm, a load application rate of 30 mN/min, an excitation amplitude of 50 μm, and an excitation frequency of 45 Hz.

### [Aspect 2]

The LDH separator according to Aspect 1, wherein the hydroxide ion-conductive layered compound fills up pores of the porous substrate.

### [Aspect 3]

The LDH separator according to Aspect 1 or 2, wherein the hydroxide ion-conductive layered compound is an LDH-like compound, and the LDH-like compound comprises (i) Mg and (ii) one or more elements comprising at least Ti, selected from the group consisting of Ti, Y and Al.

### [Aspect 4]

The LDH separator according to Aspect 1 or 2, wherein the hydroxide ion-conductive layered compound is an LDH, and the LDH is composed of a plurality of hydroxide base layers comprising Mg, Al and OH groups, and interlayers composed of anions and H₂O interposed between the plurality of hydroxide base layers.

### [Aspect 5]

The LDH separator according to Aspect 4, wherein the plurality of hydroxide base layers further comprise Ti.

### [Aspect 6]

The LDH separator according to any one of Aspects 1 to 5, wherein the surface layer has a thickness of from 0.01 to 10 μm.

### [Aspect 7]

The LDH separator according to any one of Aspects 1 to 6, wherein the LDH separator has a thickness of from 3 to 80 μm.

### [Aspect 8]

The LDH separator according to any one of Aspects 1 to 7, wherein the porous substrate is composed of a polymer material.

### [Aspect 9]

The LDH separator according to any one of Aspects 1 to 8, wherein the LDH separator has a He permeability per unit area of 10 cm/min·atm or less.

### [Aspect 10]

The LDH separator according to any one of Aspects 1 to 9, wherein the LDH separator has been pressed in a thickness direction of the LDH separator.

### [Aspect 11]

The LDH separator according to any one of Aspects 1 to 10, wherein the surface layer is free of a binder resin.

### [Aspect 12]

A method for producing an LDH separator, comprising the steps of:
covering at least one surface of a porous substrate with a binder resin, and
subjecting the porous substrate covered with the binder resin to hydrothermal treatment in a raw material aqueous solution comprising a constituent element of a hydroxide ion-conductive layered compound that is a layered double hydroxide (LDH) and/or a layered double hydroxide (LDH)-like compound to form a surface layer comprising the hydroxide ion-conductive layered compound on a surface of the porous substrate comprising the binder resin.

### [Aspect 13]

The method for producing the LDH separator according to Aspect 12, wherein covering the porous substrate with the binder resin comprises coating a surface of the porous substrate with a solution dissolving the binder resin.

### [Aspect 14]

A zinc secondary battery comprising the LDH separator according to any one of Aspects 1 to 11.

### [Aspect 15]

A solid alkaline fuel cell comprising the LDH separator according to any one of Aspects 1 to 11.

### BRIEF DESCRIPTION OF THE DRAWINGS

FIG. 1 is a schematic cross-sectional view conceptually illustrating an LDH separator of the present invention.

FIG. 2A is a conceptual view illustrating an example of a He permeability measurement system used in Examples A1 to C9.

FIG. 2B is a schematic cross-sectional view of the sample holder used in the measurement system shown in FIG. 2A and the peripheral composition thereof.

FIG. 3 is a schematic cross-sectional view of the electrochemical measurement system used in Examples A1 to C9.

FIG. 4A is a view explaining a micro-scratch test carried out in Examples A1 to C9, and is a view of an LDH separator sample, seen from the above.

FIG. 4B is a view explaining a micro-scratch test carried out in Examples A1 to C9, and is a view of an LDH separator sample, seen from the side.

### DETAILED DESCRIPTION OF THE INVENTION

### LDH Separator

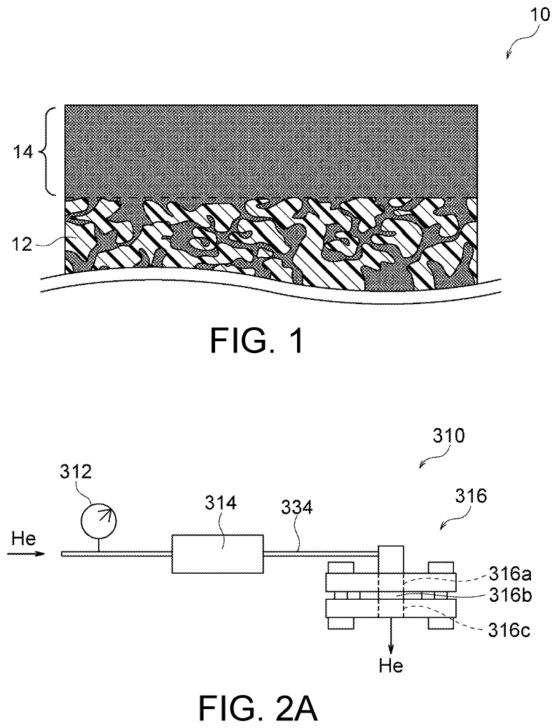

As conceptually illustrated in FIG. 1, an LDH separator 10 of the present invention comprises a porous substrate 12 and a surface layer 14 provided on at least one surface of the porous substrate 12. The surface layer 14 comprises a hydroxide ion-conductive layered compound. The hydroxide ion-conductive layered compound is a layered double hydroxide (LDH) and/or a layered double hydroxide (LDH)-like compound. The LDH separator 10 also has an ionic conductivity of 1.0 mS/cm or more, and an adhesion force of 5.0 mN or more between the surface layer 14 and the porous substrate 12. The “LDH separator” as used herein is defined as a separator comprising an LDH and/or an LDH-like compound, which allows hydroxide ions to selectively pass the separator by exclusively utilizing hydroxide-ion conductivity of LDH and/or the LDH-like compound. The “LDH-like compound” as used herein is a hydroxide and/or an oxide with a layered crystal structure which may not be called an LDH but is analogous to an LDH, and can be said to be an equivalent of LDH. However, it is also possible in a broader definition to comprehend that “LDH” includes not only an LDH but also an LDH-like compound. Thus, the LDH separator comprising the porous substrate 12 and the surface layer 14 provided on its surface, in which the separator has an ionic conductivity of 1.0 mS/cm or more, and an adhesion force between the surface layer 14 and the porous substrate 12 is 5.0 mN or more can achieve a further improvement in cycle characteristics of a battery comprising this separator.

As described above, when using a conventional LDH separator to configure a zinc secondary battery such as a nickel-zinc battery, a short circuit due to zinc dendrites and the like can be prevented to some extent, but further improvement in cycle characteristics (particularly dendrite derived short-circuit prevention characteristics in the case of repeated charge/discharge cycles), is desired. In this respect, according to the configuration of the present invention, further improvement in the cycle characteristics can be desirably achieved. The mechanism thereof is not necessarily clarified, surface defects that can develop in an LDH separator (which are considered to affect the cycle characteristics) are considered to be effectively reduced. Such surface defects can result, for example, when a surface layer is peeled off by a carrier film upon roll pressing for further densifying the LDH separator. Then, a porous substrate is exposed at a location where surface defects develop (surface layer peel-off portion), as a result of which an effect of preventing short circuits due to zinc dendrites can be poor. In this respect, in the LDH separator 10 of the present invention, the excellent adhesion force between the surface layer 14 and the porous substrate 12 is 5.0 mN or more, which can result in a separator that could prevent the surface layer 14 from peeing off, due to roll pressing or the like upon production of the LDH separator 10, and therefore the development of the surface defects in the separator is effectively inhibited, and also continues to be inhibited even thereafter (for example, after incorporation into a battery). Whereas a low ionic conductivity of the separator would adversely affect the cycle characteristics, the LDH separator 10 even has a high ionic conductivity of 1.0 mS/cm or more. Thus, according to the LDH separator of the present invention, further improvement in the cycle characteristics of a battery can be considered to be achieved compared to those by conventional LDH separators.

In the LDH separator 10, the adhesion force between the surface layer 14 and the porous substrate 12 is 5.0 mN or more, preferably 7.5 mN or more, more preferably 10.0 mN or more, and further preferably 12.5 mN or more. The higher adhesion force between the surface layer 14 and the porous substrate 12, the more favorable the adhesion force is, and the upper limit value thereof is not particularly limited, however, it is typically 70 mN or less and more typically 50 mN or less. The adhesion force is a critical load value (i.e., an application load value when a surface layer first peels off) measured by subjecting a surface including the surface layer 14 of the LDH separator 10 to a micro-scratch test. The micro-scratch test is a test method which can evaluate adhesion of a thin film with high sensitivity by pressing an indenter needle (stylus) against a test specimen at a constant load application rate and scratch rate while minutely vibrating it in a horizontal direction, and determining a load when the thin film is damaged, as specified in JIS R3255-1997. The micro-scratch test employed herein is carried out in accordance with JIS R3255-1997 under the following conditions: a scratch rate 10 μm/s, a tip curvature radius of a diamond indenter needle 25 μm, a load application rate 30 mN/min, an excitation amplitude 50 μm, and an excitation frequency 45 Hz. Moreover, the measurement of adhesion force by the micro-scratch test can be preferably carried out according to the procedure shown in the evaluation 7 of Examples described below.

The LDH separator 10 has an ionic conductivity of 1.0 mS/cm or more, preferably 1.5 mS/cm or more, more preferably 2.0 mS/cm or more, and further preferably 2.5 mS/cm or more. The upper limit of the ionic conductivity is not particularly limited, but is, for example, 10.0 mS/cm or less.

A thickness of the surface layer 14 is preferably from 0.01 to 10 μm, more preferably from 0.01 to 8 μm, further preferably from 0.05 to 8 μm, and particularly preferably from 0.05 to 5 μm. Within these ranges of the thickness, the surface layer 14 can more reliably prevent zinc dendrites from penetrating a separator, resulting in further improvement of cycle characteristics of a battery.

The surface layer 14 is preferably free of a binder resin. This can inhibit an in-plane resistivity bias of the surface layer 14 due to the binder resin, and reduce a risk of current concentration. However, it is acceptable for the surface layer 14 to contain a binder resin as an unavoidable impurity. That is, the surface layer 14 is preferably composed of a hydroxide ion-conductive layered compound and in some case the unavoidable impurity. For example, the LDH separator 10 may contain a binder resin as a surface adhesive layer at an interface between the porous substrate 12 and the surface layer 14, and in such a case, the binder resin is mixed as an unavoidable impurity into the surface layer 14, due to the surface adhesive layer. The amount of unavoidable impurity that can be contained in the surface layer 14 is typically 0.1 wt % or less.

The denseness of the LDH separator 10 can be evaluated by He permeability. Namely, the LDH separator 10 preferably has a He permeability per unit area of 10 cm/min·atm or less, more preferably 5.0 cm/min-atm or less, and further preferably 1.0 cm/min·atm or less. The LDH separator 10 with He permeability within such ranges can be said to have extremely high denseness. Therefore, a separator having a He permeability of 10 cm/min·atm or less can block passage of substances other than hydroxide ions at a high level. For example, in the case of a zinc secondary battery, permeation of Zn (typically permeation of zinc ions or zincate ions) in an electrolytic solution can be inhibited extremely effectively. The He permeability is measured via a step of supplying He gas to one surface of a separator to allow it to permeate the He gas, and a step of calculating a He permeability and evaluating a denseness of the hydroxide-ion conductive separator. The He permeability is calculated by the formula of F/(P×S) using a permeation amount F of He gas per unit time, a differential pressure P applied to a separator when the He gas permeates, and a membrane area S through which the He gas permeates. By evaluating the gas permeability using the He gas in such a manner, it is possible to evaluate denseness (dense or sparse) at an extremely high level, and as a result, it is possible to effectively evaluate a high denseness such that substances other than hydroxide ions (particularly Zn bringing about zinc dendrite growth) are not allowed to be permeated as much as possible (only a trace amount is permeated). This is because He gas has the smallest constituent unit among a wide variety of atomic and molecular species that can compose a gas, and has extremely low reactivity. Namely, a single He atom composes He gas without forming a molecule. In this respect, since a hydrogen gas is composed of H₂ molecules, the single He atom is smaller as a gas constituent unit. In the first place, H₂ gas is dangerous because it is a flammable gas. Then, by adopting an index of the He gas permeability defined by the above formula, it is possible to easily conduct objective evaluation relating to the denseness regardless of differences in various sample sizes and measurement conditions. Thus, it is possible to easily, safely, and effectively evaluate whether or not the separator has a sufficiently high denseness suitable for a separator for zinc secondary batteries. The measurement of the He permeability can preferably be conducted according to the procedure described in Evaluation 4 in Examples described below.

In the LDH separator 10, the hydroxide ion-conductive layered compound preferably fills up pores of the porous substrate 12. According to such an aspect, the hydroxide ion-conductive layered compound is connected between an upper surface and a bottom surface of the porous substrate 12, as a result of which a hydroxide ion conductivity of the LDH separator 10 is ensured. The hydroxide ion-conductive layered compound is particularly preferably incorporated throughout a thickness direction of the porous substrate 12. However, the pores in the porous substrate 12 are not necessarily completely filled up, and residual pores may be slightly present. Alternatively, in the LDH separator 10, the hydroxide ion-conductive layered compound may not fill up pores of the porous substrate 12. The thickness of the LDH separator 10 (i.e., the total thickness of the porous substrate 12 and the surface layer 14) is preferably from 3 to 80 μm, more preferably from 3 to 60 μm, and further preferably from 3 to 40 μm.

LDH is composed of a plurality of hydroxide base layers and interlayers interposed therebetween. The hydroxide base layer is composed mainly of a metallic element (typically a metal ion) and OH groups. The interlayers of LDH are composed of anions and H₂O. The anion is a monovalent or higher anion, preferably a monovalent or divalent ion. An anion in LDH preferably contains OH⁻ and/or CO₃²⁻. LDH also has excellent ionic conductivity due to its inherent properties. In general, LDH has been known to be represented by the basic compositional formula M²⁺₁₋ₓM³⁺ₓ(OH)₂Aⁿ⁻_{x/n}·mH₂O where M²⁺ is a divalent cation and M³⁺ is a trivalent cation, Aⁿ⁻ is an n-valent anion, n is an integer of 1 or greater, x is 0.1 to 0.4, and m is 0 or greater. In the above basic compositional formula, M²⁺ can be any divalent cation, but examples thereof preferably include Mg²⁺, Ca²⁺, and Zn²⁺ and more preferably Mg²⁺. M³⁺ can be any trivalent cation, but examples thereof include preferably Al³⁺ or Cr³⁺ and more preferably Al³⁺. An can be any anion, however, preferred examples thereof include OH and/or CO₃²⁻. Therefore, in the above basic compositional formula, M²⁺ preferably contains Mg²⁺, M³⁺ preferably contains Al³⁺, and Aⁿ⁻ preferably contains OH and/or CO₃²⁻. n is an integer of 1 or greater, but preferably 1 or 2. x is 0.1 to 0.4, but preferably 0.2 to 0.35. m is an arbitrary numeral denoting the number of moles of water, and is 0 or greater, typically a real number greater than 0 or 1 or greater. However, the above basic compositional formula is only the “basic compositional” formula that is representatively exemplified for LDH, and the constituent ions can be appropriately replaced. For example, in the above basic compositional formula, some or all of M³⁺ may be replaced with a tetravalent cation or a cation with higher valence (for example, Ti⁴⁺), in which case a coefficient x/n of anion Aⁿ⁻ in the above formula may be changed as appropriate.

For example, the hydroxide base layers of LDH preferably contain Mg, Al and OH groups, and particularly preferably further contain Ti (i.e., the hydroxide base layers contain Mg, Al, Ti, and OH groups) in terms of exhibiting excellent alkaline resistance. In this case, the hydroxide base layers may contain an additional element or ion as long as they contains Mg, Al and OH groups (and further Ti if desired). For example, the LDH or hydroxide base layer may comprise Y and/or Zn. Moreover, when Y and/or Zn is contained in the LDH or hydroxide base layer, Al or Ti may not be contained in the LDH or hydroxide base layer. However, the hydroxide base layer preferably comprises Mg, Al, Ti, and OH groups as major components. Namely, the hydroxide base layer is preferably mainly composed of Mg, Al, Ti, and OH groups. Therefore, the hydroxide base layer is typically composed of Mg, Al, Ti, OH groups and, in some cases, unavoidable impurities. The atomic ratio of Ti/Al in the LDH is preferably 0.5 to 12 and more preferably 1.0 to 12, as determined by energy dispersive X-ray spectroscopy (EDS). Within the above range, the effect of inhibiting a short circuit caused by zinc dendrites (i.e., dendrite resistance) can be more effectively realized without impairing an ionic conductivity. For the same reason, the atomic ratio of Ti/(Mg+Ti+Al) in the LDH, as determined by energy dispersive X-ray spectroscopy (EDS), is preferably 0.1 to 0.7 and more preferably 0.2 to 0.7. Moreover, the atomic ratio of Al/(Mg+Ti+Al) in the LDH is preferably 0.05 to 0.4 and more preferably 0.05 to 0.25. Further, the atomic ratio of Mg/(Mg+Ti+Al) in the LDH is preferably 0.2 to 0.7 and more preferably 0.2 to 0.6. The EDS analysis is preferably carried out with an EDS analyzer (for example, X-act manufactured by Oxford Instruments) by 1) capturing an image at an accelerating voltage of 20 kV and a magnification of 5,000 times, 2) carrying out a three-point analysis at about 5 μm intervals in a point analysis mode, 3) repeating the above 1) and 2) once more, and 4) calculating an average value of a total of 6 points.

Alternatively, the hydroxide base layer of LDH may contain Ni, Al, Ti and OH groups. In this case, the hydroxide base layer may contain other elements or ions as long as it contains Ni, Al, Ti, and OH groups. However, the hydroxide base layer preferably contains Ni, Al, Ti, and OH groups as major components. That is to say, the hydroxide base layer is preferably composed mainly of Ni, Al, Ti, and OH groups. The hydroxide base layer is therefore typically composed of Ni, Al, Ti, OH groups, and unavoidable impurities in case. An atomic ratio of Ti/(Ni+Ti+Al) in the LDH, as determined by energy dispersive X-ray analysis (EDS), is preferably 0.10 to 0.90, more preferably 0.20 to 0.80, still more preferably 0.25 to 0.70, and particularly preferably 0.30 to 0.61. The ratio within the above range can improve both alkali resistance and ionic conductivity. Thus, the hydroxide ion-conductive layered compound may contain not only an LDH but also Ti so much that titania is formed as by-product. That is to say, the hydroxide ion-conductive layered compound may further contain titania. The inclusion of titania is expected to increase hydrophilicity and improve wettability with an electrolytic solution (i.e., increase in conductivity).

The LDH-like compound is a hydroxide and/or an oxide with a layered crystal structure which may not be called an LDH but is analogous to an LDH, and the LDH-like compound preferably contains (i) Mg and (ii) one or more elements containing at least Ti, selected from the group consisting of Ti, Y, and Al. Thus, using the LDH-like compound, which is a hydroxide and/or an oxide with a layered crystal structure containing at least Mg and Ti, as a hydroxide ion-conductive material, instead of a conventional LDH, can provide a hydroxide ion-conductive separator excellent in alkali resistance and is capable of even more effectively inhibiting short circuits due to by zinc dendrites. Therefore, a preferred LDH-like compound is a hydroxide and/or an oxide with a layered crystal structure, containing (i) Mg and (ii) one or more elements containing at least Ti, selected from the group consisting of Ti, Y and Al. Thus, a typical LDH-like compound is a complex hydroxide and/or a complex oxide of Mg, Ti, optional Y, and optional Al, and is particularly preferably a complex hydroxide and/or a complex oxide of Mg, Ti, Y and Al. The above elements may be replaced by other elements or ions to the extent that the basic properties of the LDH-like compound are not impaired; however, the LDH-like compound is preferably free of Ni.

The LDH-like compound can be identified by X-ray diffraction. Specifically, when a surface of the LDH separator on the surface layer 14 side is subjected to X-ray diffraction, a peak derived from the LDH-like compound is typically detected in a range of 5°≤2θ≤10° and more typically in the range of 7°≤2θ≤10°. As described above, LDH is a substance with an alternating stacked structure in which an exchangeable anion and H₂O are present as interlayers between the stacked hydroxide base layers. In this respect, when an LDH is subjected to the measurement by the X-ray diffraction method, a peak derived from a crystal structure of an LDH (i.e., the (003) peak of LDH) is intrinsically detected at the position of 2θ=11 to 12°. To the contrary, when an LDH-like compound is subjected to the measurement by the X-ray diffraction method, a peak is detected typically in the above-mentioned range, which is shifted to a lower angle side than the above peak position of the LDH. Using 20 corresponding to the peak derived from the LDH-like compound in the X-ray diffraction, it is possible to determine the interlayer distance of a layered crystal structure according to the Bragg's formula. The interlayer distance of the layered crystal structure constituting the LDH-like compound thus determined is typically 0.883 to 1.8 nm and more typically 0.883 to 1.3 nm.

An atomic ratio of Mg/(Mg+Ti+Y+Al) in the LDH-like compound, as determined by energy dispersive X-ray spectroscopy (EDS), is preferably 0.03 to 0.25 and more preferably 0.05 to 0.2. Moreover, an atomic ratio of Ti/(Mg+Ti+Y+Al) in the LDH-like compound is preferably 0.40 to 0.97 and more preferably 0.47 to 0.94. Furthermore, an atomic ratio of Y/(Mg+Ti+Y+Al) in the LDH-like compound is preferably 0 to 0.45 and more preferably 0 to 0.37. Then, an atomic ratio of Al/(Mg+Ti+Y+Al) in the LDH-like compound is preferably 0 to 0.05 and more preferably 0 to 0.03. The ratio within the above range renders alkali resistance more excellent and can more effectively achieve inhibition effect of short circuits due to zinc dendrites (i.e., dendrite resistance). By the way, LDH that has been conventionally known regarding an LDH separator can be represented by the general formula of a basic composition: M²⁺₁₋ₓM³⁺ₓ(OH)₂Aⁿ⁻_{x/n}·mH₂O where M²⁺ is a divalent cation and M³⁺ is a trivalent cation, Aⁿ⁻ is an n-valent anion, n is an integer of 1 or greater, x is 0.1 to 0.4, and m is 0 or greater. On the other hand, the above atomic ratio in the LDH-like compound generally deviates from the atomic ratio in the above general formula of LDH. Therefore, the LDH-like compound can be generally said to have a composition ratio (atomic ratio) that is different from that of a conventional LDH. In this connection, the EDS analysis is preferably carried out with an EDS analyzer (for example, X-act manufactured by Oxford Instruments) by 1) capturing an image at an accelerating voltage of 20 kV and a magnification of 5,000 times, 2) carrying out a three-point analysis at about 5 μm intervals in a point analysis mode, 3) repeating the above 1) and 2) once more, and 4) calculating an average value of a total of 6 points.

The LDH separator 10 isolates a positive electrode plate and a negative electrode plate so as to be hydroxide-ion conductive when incorporated in a zinc secondary battery. The preferred LDH separator 10 has a gas impermeability and/or a water impermeability. In other words, the LDH separator 10 (particularly the surface layer 14) is preferably densified to such an extent that it has a gas impermeability and/or a water impermeability. Incidentally, as described in Patent Literatures 2 and 3 and used herein, “having a gas impermeability” means that even if helium gas is brought into contact with one side of an object to be measured in water at a differential pressure of 0.5 atm, generation of bubbles due to helium gas is not observed from another side. Moreover, as described in Patent Literatures 2 and 3 and used herein, “having a water impermeability” refers to allowing no permeation of water in contact with one side of an object to be measured to another side. Namely, the LDH separator 10 having a gas impermeability and/or a water impermeability refers to the LDH separator 10 having a high denseness to the degree that it does not allow a gas or water to pass through, and refers not to a porous film or other porous material that has a water permeability or a gas permeability. In such a manner, the LDH separator 10 selectively allows only hydroxide ions to pass through due to its hydroxide-ion conductivity, and can exhibit a function as a battery separator. Therefore, the composition thereof is extremely effective in physically blocking penetration of the separator by the zinc dendrites generated upon charge to prevent a short circuit between the positive and negative electrodes. Since the LDH separator 10 has a hydroxide-ion conductivity, it enables efficient movement of necessary hydroxide ions between the positive electrode plate and the negative electrode plate, and can realize a charge/discharge reaction in the positive electrode plate and the negative electrode plate.

The porous substrate 12 is preferably composed of a polymer material. The polymer porous substrate has advantages of 1) flexibility (hence, it is hard to break even if being thin.), 2) facilitation of increase in porosity, 3) facilitation of increase in a conductivity (because it can be rendered thin while increasing porosity.), and 4) facilitation of manufacture and handling. Moreover, by taking advantage of the flexibility of 1) above, it also has 5) an advantage of capable of easily bending or jointing by sealing, a hydroxide-ion conductive separator comprising a porous substrate made of a polymer material. The polymer material preferably includes, for example, polystyrene, polyether sulfone, polypropylene, an epoxy resin, polyphenylene sulfide, a fluororesin (tetrafluororesin: PTFE, etc.), cellulose, nylon, polyethylene, and any combination thereof. More preferably, from the viewpoint of a thermoplastic resin suitable for heat pressing, it includes polystyrene, polyether sulfone, polypropylene, epoxy resin, polyphenylene sulfide, a fluororesin (tetrafluororesin: PTFE, etc.), nylon, polyethylene, any combination thereof, etc. All of the various preferred materials described above have alkali resistance as resistance to an electrolytic solution of a battery. The polymer materials are particularly preferably polyolefins such as polypropylene and polyethylene, and most preferably polypropylene or polyethylene, in terms of excellent hydrothermal resistance, acid resistance, and alkali resistance as well as low cost. The hydroxide ion-conductive layered compound is particularly preferably incorporated over the entire region of the porous substrate 12 in the thickness direction thereof (for example, the hydroxide ion-conductive layered compound fills up most or almost all pores inside the polymer porous substrate.). As such a polymer porous substrate, a commercially available polymer microporous membrane can preferably be used.

### Method for Producing LDH Separator

The LDH separator of the present invention can be preferably produced by (1) covering a surface of the porous substrate with the binder resin, (2) subjecting the porous substrate to hydrothermal treatment in a raw material aqueous solution to form a surface layer comprising the hydroxide ion-conductive layered compound on a surface of the porous substrate comprising the binder resin.

(1) Covering of Porous Substrate with Binder Resin

At least one surface of the porous substrate 12 is covered with a binder resin. The porous substrate 12 is as described above, and is preferably a polymeric porous substrate for use. Preferred examples of the binder resin include polyolefins (for example, a polypropylene and polyethylene), a polystyrene, a polyether sulfone, an epoxy resin, a polyphenylene sulfide, a fluororesin, cellulose, nylon, acrylonitrile styrene, a polysulfone, an acrylonitrile·butadiene·styrene (ABS) resin, a polyvinyl chloride, an acetal resin, a polyvinyl alcohol (PVA) resin, a polyvinylidene dichloride, a polyvinylidene difluoride, a phenolic resin, an allyl resin, a furan resin, and arbitrary combinations thereof. A more preferable examples thereof include the polyolefin, from the viewpoint of improving adhesiveness between the surface layer 14 and the porous substrate 12 (particularly a polymeric porous substrate). The polymers or resins listed above may be unmodified or modified. For example, the polyolefin may be a modified polyolefin.

Covering the porous substrate 12 with the binder resin preferably comprises coating a surface of the porous substrate 12 with a solution dissolving the binder resin. The concentration of the binder resin contained in the solution is preferably from 0.5 to 10 wt % and more preferably from 1 to 5 wt %. Examples of preferred coating methods include dip coating, filtration coating, etc., and the dip coating is particularly preferred. Adjusting a concentration of the binder resin contained in the solution and/or the number of times of coating such as dip coating makes it possible to adjust the amount of binder resin adhered. The amount of binder resin adhered per 1 cm³ of the substrate is preferably from 14 to 290 mg and more preferably from 30 to 150 mg. The substrate coated with the binder resin may be dried and then subjected to hydrothermal treatment as described below.

### (2) Formation of Surface Layer by Hydrothermal Treatment

In a raw material aqueous solution containing a constituent element of a hydroxide ion-conductive layered compound that is the layered double hydroxide (LDH) and/or the layered double hydroxide (LDH)-like compound, the porous substrate 12 covered with the binder resin is subjected to hydrothermal treatment. Such treatment can form the surface layer 14 containing the hydroxide ion-conductive layered compound on a surface of the porous substrate 12 containing the binder resin to obtain the LDH separator 10. According to such a production method, the binder resin is present at an interface between the porous substrate 12 and the surface layer 14. In other words, the binder resin with which the substrate surface was coated functions as a surface layer adhesive layer, thereby improving adhesiveness between the porous substrate 12 and the surface layer 14. As a result, surface layer-peel off (surface defects) can be prevented to further improve the cycle characteristics of a battery.

The surface layer 14 accompanied by hydrothermal treatment can be formed by appropriately changing various conditions of known methods for producing LDH separators (or an LDH-containing functional layer and a composite material) (see, for example, Patent Literatures 1 to 5). The LDH separator 10 can be preferably produced, for example, by (a) coating the porous substrate 12 covered with the binder resin with a solution containing i) alumina sol (or further titania sol) (in the case of forming an LDH) or ii) titania sol (or further yttria sol and/or alumina sol) (in the case of forming an LDH-like compound), followed by drying, (b) immersing the porous substrate 12 in a raw material aqueous solution containing magnesium ions (Mg²⁺) and a urea (or further yttrium ions (Y³⁺)), and (c) subjecting the porous substrate 12 to hydrothermal treatment in the raw material aqueous solution to form a hydroxide ion-conductive layered compound on and/or in the porous substrate.

At this time, it is conjectured that the presence of urea in the above step (b) generates ammonia in the solution by utilizing hydrolysis of urea and raises a pH value, and the coexisting metal ions form a hydroxide and/or an oxide, making it possible to obtain a hydroxide ion-conductive layered compound (i.e., an LDH and/or an LDH-like compound). Moreover, since hydrolysis is accompanied by generation of carbon dioxide, when an LDH is formed, the LDH having an anion of carbonate ion type can be obtained.

In particular, in the case of fabricating an LDH separator 10 in which the hydroxide ion-conductive layered compound is incorporated over the entire region of the porous substrate 12 in the thickness direction thereof, it is preferred to coat the substrate with the sol solution in the above (a) in such a procedure as to permeate the sol solution into the whole or most of the inside of the substrate, which thereby makes it possible to finally fill most or almost all pores inside the porous substrate 12 with the hydroxide ion-conductive layered compound. The coating method preferably includes, for example, a dip coating and a filtration coating, and the dip coating is particularly preferred. The amount of the sol solution adhered can be adjusted by adjusting the number of times of coating in the dip coating, etc. After the substrate coated with the sol solution by the dip coating, etc., was dried, the above steps (b) and (c) may be carried out.

The LDH separator obtained by the above method or the like may be subjected to pressing treatment. Thereby an LDH separator excellent in a higher denseness can be obtained. Therefore, it is preferable that the LDH separator 10 of the present invention has been pressed in the thickness direction. The pressing method may be, for example, roll pressing, uniaxial pressing, or CIP (cold isostatic pressing), and it is not particularly limited, but is preferably roll pressing. This pressing with heating softens the polymer porous substrate, thereby enabling the hydroxide ion-conductive layered compound to sufficiently fill up pores of the polymer porous substrate, which is preferred. For sufficient softening, for example, in the case of polypropylene or polyethylene, it is preferred to heat the polymer at 60 to 200° C. Pressing such as roll pressing in such a temperature range can significantly reduce the residual pores of the LDH separator. As a result, the LDH separator can be extremely highly densified and therefore short circuits caused by zinc dendrites can be inhibited even more effectively. In roll pressing, morphology of residual pores can be controlled by appropriately adjusting a roll gap and a roll temperature, whereby an LDH separator having a desired denseness can be obtained.

### Zinc Secondary Battery

The LDH separator of the present invention is preferably applied to a zinc secondary battery. Therefore, according to a preferred aspect of the present invention, a zinc secondary battery comprising an LDH separator is provided. A typical zinc secondary battery comprises a positive electrode, a negative electrode, and an electrolytic solution, and the positive electrode and the negative electrode are separated from each other with an LDH separator interposed therebetween. The zinc secondary battery of the present invention is not particularly limited provided that it is a secondary battery in which zinc is used as a negative electrode and an electrolytic solution (typically an alkali metal hydroxide aqueous solution) is used. Therefore, it can be a nickel-zinc secondary battery, a silver oxide-zinc secondary battery, a manganese oxide-zinc secondary battery, a zinc-air secondary battery, or various other alkaline-zinc secondary batteries. For example, a positive electrode preferably comprises nickel hydroxide and/or nickel oxyhydroxide whereby the zinc secondary battery forms a nickel-zinc secondary battery. Alternatively, the positive electrode may be an air electrode whereby the zinc secondary battery forms a zinc-air secondary battery.

### Solid Alkaline Fuel Cell

The LDH separator of the present invention can also be applied to a solid alkaline fuel cell. Namely, by using the highly densified LDH separator, the solid alkaline fuel cell can be provided, which is capable of effectively inhibiting reduction of an electromotive force due to permeation of a fuel to an air electrode side (for example, crossover of methanol). This is because the permeation of the fuel such as methanol to the LDH separator can be effectively inhibited while exhibiting the hydroxide-ion conductivity of the LDH separator. Therefore, according to another preferred aspect of the present invention, a solid alkaline fuel cell comprising the LDH separator is provided. A typical solid alkaline fuel cell according to the aspect includes an air electrode to which oxygen is supplied, a fuel electrode to which a liquid fuel and/or a gaseous fuel are supplied, and an LDH separator interposed between the fuel electrode and the air electrode.

### Other Batteries

The LDH separator of the present invention can be used not only for nickel-zinc batteries and solid alkaline fuel cells, but also for nickel-hydrogen batteries, for example. In this case, the LDH separator functions to block the nitride shuttle (movement of nitric acid groups between electrodes), which is a factor of self-discharge of the battery. Moreover, the LDH separator of the present invention can also be used for a lithium battery (a battery having a negative electrode made of lithium metal), a lithium ion battery (a battery having a negative electrode made of carbon, etc.), or a lithium-air battery, etc.

### EXAMPLES

The present invention will be further specifically described by way of the following Examples. It is noted that the evaluation methods of the LDH separator produced in the following Examples are as follows.

### Evaluation 1: Observation of Microstructure

A surface microstructure of an LDH separator was observed by using a scanning electron microscope (SEM, JSM-6610LV, manufactured by JEOL Ltd.) at an accelerating voltage of 10 to 20 kV.

### Evaluation 2: Elemental Analysis Evaluation (EDS)

Composition analysis was carried out on a surface of an LDH separator by using an EDS analyzer (apparatus name: X-act, manufactured by Oxford Instruments) to confirm incorporation of prescribed elements in crystals. This analysis was carried out by 1) capturing an image at an accelerating voltage of 20 kV and a magnification of 5,000 times, 2) carrying out a three-point analysis at about 5 μm intervals in a point analysis mode, and 3) repeating the above 1) and 2) once more.

### Evaluation 3: Identification of Hydroxide Ion-Conductive Layered Compound

An XRD profile was obtained by measuring a crystal phase of the hydroxide ion-conductive layered compound with an X-ray diffractometer (RINT TTR III manufactured by Rigaku Corporation) under the measurement conditions of voltage: 50 kV, current value: 300 mA, and measurement range: 5 to 70°.

### Evaluation 4: He Permeation Measurement

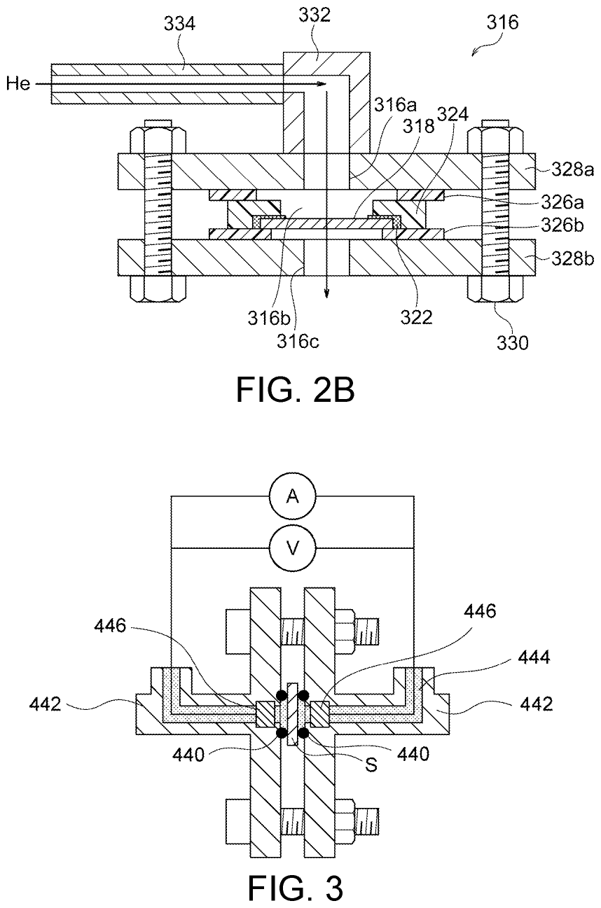

From the viewpoint of a He permeability, a He permeation test was carried out as follows in order to evaluate a denseness of an LDH separator. First, the He permeability measurement system 310 shown in FIG. 2A and FIG. 2B was built up. The He permeability measurement system 310 was constituted so that He gas from a gas cylinder filled with the He gas was supplied to a sample holder 316 via a pressure gauge 312 and a flow meter 314 (digital flow meter), and it was permeated from one surface of an LDH separator 318 held in the sample holder 316 to the other surface and discharged.

The sample holder 316 has a structure including a gas supply port 316a, a closed space 316b, and a gas discharge port 316c, and was assembled as follows. First, an adhesive 322 was applied along an outer circumference of the LDH separator 318 and attached to a jig 324 (made of an ABS resin) having an opening in the center. A packing made of butyl rubber was arranged as sealing members 326a and 326b at the upper end and lower end of the jig 324, and was further sandwiched by support members 328a and 328b (made of PTFE) having openings that were made from flanges, from the outside of the sealing members 326a and 326b. In this manner, the closed space 316b was partitioned by the LDH separator 318, the jig 324, the sealing member 326a, and the support member 328a. The support members 328a and 328b were firmly tightened to each other by a fastening means 330 using screws so that He gas did not leak from portions other than a gas discharge port 316c. A gas supply pipe 334 was connected to the gas supply port 316a of the sample holder 316 thus assembled via a joint 332.

Next, He gas was supplied to the He permeability measurement system 310 via the gas supply pipe 334, and was permeated through the LDH separator 318 held in the sample holder 316. At this time, a gas supply pressure and a flow rate were monitored by the pressure gauge 312 and the flow meter 314. After permeating the He gas for 1 to 30 minutes, a He permeability was calculated. The He permeability was calculated by the formula of F/(P×S) using a permeation amount F (cm³/min) of the He gas per unit time, a differential pressure P (atm) applied to the LDH separator when the He gas permeates, and a membrane area S (cm²) through which the He gas permeates. The permeation amount F (cm³/min) of the He gas was read directly from the flow meter 314. Moreover, as the differential pressure P, a gauge pressure read from the pressure gauge 312 was used. The He gas was supplied so that the differential pressure P was in the range of 0.05 to 0.90 atm.

### Evaluation 5: Measurement of Ionic Conductivity

A conductivity of an LDH separator in an electrolytic solution was measured as follows by using the electrochemical measurement system shown in FIG. 3. The LDH separator sample S was sandwiched with 1 mm thick silicone packings 440 from both sides of the sample and incorporated into a PTFE flange type cell 442 having an inner diameter of 6 mm. As an electrode 446, a nickel wire mesh of #100 mesh was incorporated into the cell 442 in a cylindrical fashion having a diameter of 6 mm, so that a distance between the electrodes was 2.2 mm. As an electrolytic solution 444, a 6 M KOH aqueous solution was filled in the cell 442. By using an electrochemical measurement system (potentio/galvanostat-frequency response analyzer manufactured by Solartron Analytical, type: 1287A and 1255B), measurement was carried out under the conditions of a frequency range of 1 MHz to 0.1 Hz and an applied voltage of 10 mV, and an intercept of a real number axis was used as a resistance of the LDH separator sample S. The same measurement as above was carried out without the LDH separator sample S, and a blank resistance was also determined. The difference between the resistance of the LDH separator sample S and the blank resistance was defined as a resistance of the LDH separator. The conductivity was determined by using the resistance of the obtained LDH separator and a thickness and an area of the LDH separator.

### Evaluation 6: Evaluation of Dendrite Resistance (Cycle Test)

A cycle test was carried out in order to evaluate an effect of the LDH separator inhibiting a short circuit due to zinc dendrites (dendrite resistance) as follows. First, a positive electrode (containing nickel hydroxide and/or nickel oxyhydroxide) and a negative electrode (containing zinc and/or zinc oxide) were each wrapped in a nonwoven fabric and current extraction terminals were welded. The positive electrode and the negative electrode thus prepared were placed facing each other via the LDH separator, sandwiched between laminated films with current outlets, which were thermally fused together on three sides thereof. The thus obtained cell container with an upper portion open was added with an electrolytic solution (0.4 M zinc oxide dissolved in a 5.4 M KOH aqueous solution), which was sufficiently permeated into the positive electrode and the negative electrode by vacuuming, etc. Thereafter, the remaining each side of the laminated films was also thermally fused to form a simple sealed cell. Using a charge/discharge apparatus (TOSCAT 3100, manufactured by Toyo System Co., Ltd.), the simple sealed cell underwent chemical conversion at 0.1 C charge and 0.2 C discharge. Thereafter, a 1 C charge/discharge cycle was then performed. While repeated charge/discharge cycles were performed under the same conditions, the voltage between the positive electrode and the negative electrode was monitored with a voltmeter to investigate occurrence or non-occurrence of sudden voltage drop between the positive electrode and the negative electrode (specifically, a voltage drop of 5 mV or more with respect to voltage plotted immediately before) accompanying a short circuit due to zinc dendrites, and the results were evaluated based on the following criteria. Non-occurrence of short-circuit: No sudden voltage drop was observed during charge even after the specified cycles.

Occurrence of short-circuit: Sudden voltage drop was observed during charge in less than the specified cycles.

### Evaluation 7: Adhesion Force Measurement (Micro-Scratch Test)

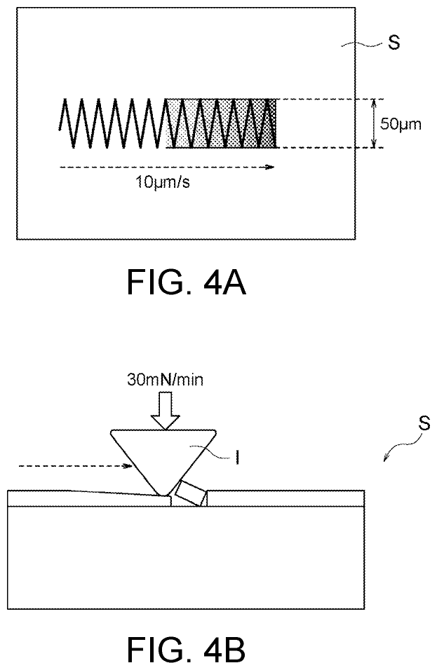

In order to evaluate adhesion force between the substrate and surface layer of the LDH separator, a micro-scratch test was carried out as follows in accordance with JIS R3255-1997. First, an LDH separator sample was placed on a sample stage of an ultrathin film scratch tester (CSR5100, manufactured by RHESCA CO., LTD.) with a surface layer of the LDH separator sample facing up, and a diamond indenter needle (tip curvature radius 25 μm, model number: S.N.D-0056) was brought into contact with the surface layer of LDH separator sample. Thereafter, while the indenter needle was minutely vibrated in the horizontal direction (vertical direction in the figure) with an excitation amplitude of 50 μm and an excitation frequency of 45 Hz, as shown in FIG. 4A, an LDH separator sample S was scratched with the indenter needle toward the width direction (horizontal direction in the figure) of the sample at a scratch rate of 10 μm/s. At this time, as shown in FIG. 4B, a load of an indenter needle I applied to a surface of the LDH separator sample S was gradually increased at a load application rate of 30 mN/min. Then the point at which the surface layer of the LDH separator sample S was peeled off by the indenter needle I was detected by an acceleration sensor (vertical direction) and an electromagnetic coil (horizontal direction), and the application load (mN) at this time was the adhesion force between the substrate and the surface layer. The above operation was repeated three times, and the average value of the adhesion force calculated for a total of three points was used as adhesion force of the LDH separator. Note, however, the above measurements were carried out under standard conditions of temperature and humidity (temperature 23° C. and relative humidity 50%).

### Examples A1-A6

LDH separators comprising an Mg—Al-LDH were fabricated and evaluated as follows.

### (1) Preparation of Polymer Porous Substrate

A commercially available polyethylene microporous membrane having a porosity of 50%, an average pore diameter of 0.1 μm, and a thickness of 10 μm was prepared as a polymer porous substrate and cut out to a size of 5.0 cm×5.0 cm.

### (2) Primer Treatment of Polymer Porous Substrate

The substrate prepared in (1) above was coated with a binder solution containing a modified polyolefin resin (AUROREN® AE-202, manufactured by Nippon Paper Industries Co., Ltd.) in the concentration shown in Table 1 by dip coating. The dip coating was carried out by immersing the substrate in 100 ml of the binder solution and then pulling it up vertically. Thereafter, the dip-coated substrate was dried at room temperature for 1 hour. Thus, a substrate coated with binder resin was obtained. Herein, the weight of the binder resin adhered with which the porous substrate was coated (per 1 cm³ of the porous substrate) is shown in Table 1. The adhered weight was calculated by subtracting the weight W₀ (mg) of the porous substrate before primer treatment from the weight W₁ (mg) of the porous substrate after primer treatment and dividing the result by the volume V (cm³) of the porous substrate (=(W₁−W₀)/V).

### (3) Alumina Sol Coating on Polymer Porous Substrate

The substrate subjected to primer treatment in (2) above was coated with an amorphous alumina solution (Al-L7, manufactured by Taki Chemical Co., Ltd.) by dip coating. Dip coating was carried out by immersing the substrate in 100 ml of the sol solution and then pulling it up vertically. Thereafter, the dip-coated substrate was dried at room temperature for 1 hour.

### (4) Preparation of Raw Material Aqueous Solution

Magnesium nitrate hexahydrate (Mg(NO₃)₂·6H₂O, manufactured by Kanto Chemical Co., Inc.) and urea ((NH₂)₂CO, manufactured by Sigma-Aldrich Co. LLC) were prepared as raw materials. The raw materials were weighed so that the magnesium nitrate hexahydrate was 0.015 mol/L and urea/NO₃ (molar ratio)=32 and placed in a beaker, and ion-exchanged water was added thereto to have a total volume of 80 ml. Thereafter the mixture was stirred to obtain a raw material aqueous solution.

### (5) Membrane Formation by Hydrothermal Treatment

Both the raw material aqueous solution and the substrate dip-coated with the sol solution in (3) above were sealed in a Teflon® airtight container (autoclave container having a content of 100 ml and an outer side jacket made of stainless steel). At this time, a substrate was fixed while being floated from the bottom of the Teflon® airtight container, and installed vertically so that the solution was in contact with both sides of the substrate. Thereafter, an LDH was formed on the surface and the inside of the substrate by subjecting it to hydrothermal treatment at a hydrothermal temperature of 90° C. for 16 hours. With an elapse of the predetermined time, the substrate was taken out from the airtight container, washed with ion-exchanged water, and dried at room temperature over night to form an LDH on a surface of the porous substrate and inside pores thereof. Thus, an LDH separator was obtained.

### (6) Densification by Roll Pressing

The above LDH separator was sandwiched between a pair of PET films (Lumiler® manufactured by Toray Industries, Inc., thickness of 40 μm), and roll-pressed at a roll rotation speed of 3 mm/s, a roller heating temperature of 70° C., and a roll gap of 70 μm to obtain a further densified LDH separator.

### (7) Various Evaluations

The obtained LDH separators underwent evaluations 1 to 7. The results were as follows.
Evaluation 1: Multiple platy crystals characteristic of LDH were confirmed.
Evaluation 2: As a result of EDS elemental analysis, Mg and Al that were constituent elements of LDH, were detected. That is to say, these elements were confirmed to be incorporated and crystallized as a hydroxide ion-conductive layered compound.
Evaluation 3: In an XRD profile, a peak was observed in the vicinity of 2θ=11.5°, which was identified to be an LDH (hydrotalcites compound). The identification was carried out by using a diffraction peak of the LDH (hydrotalcites compound) described in JCPDS card No. 35-0964.
Evaluation 4: As shown in Table 1, the extremely high denseness such as a He permeability of 0.00 cm/min·atm, was confirmed. Note, Table 1 also shows the He permeability of the porous substrate after primer treatment.
Evaluation 5: As shown in Table 1, the higher ionic conductivity (1.0 mS/cm or more) was confirmed in Examples A1 to A4 than that in Examples A5 and A6 (Comparative Examples).
Evaluation 6: As shown in Table 1, the excellent cycle durability performance (dendrite resistance) such that no short circuits occurred due to zinc dendrites even after 200 cycles, was confirmed in Examples A3 and A4. In Examples A1, A2, A5, and A6 (Comparative Examples), on the other hand, the short circuits due to zinc dendrites occurred after less than 200 cycles, which indicated that the poor cycle durability performance resulted.
Evaluation 7: In Examples A3 to A6, the more adhesion force (5.0 mN or more) was confirmed than that in Examples A1 and A2 (Comparative Examples).

TABLE 1

| | | | | | | | Cycle |
|---|---|---|---|---|---|---|---|
| | | | | | | | characteristics |
| | | | | | | | Short circuit at |
| | Primer treatment | | | After synthesis | | | 200 cycles |
| | Binder | Adhered | He | He | Ionic | Adhesion | (occurrence |
| | concentration | weight | permeability | permeability | conductivity | force | or non- |
| Mg-Al | (wt %) | (mg/cm³) | (cm/min · atm) | (cm/min · atm) | (mS/cm) | (mN) | occurrence) |
| Example | 0 | 0 | 2950 | 0.00 | 2.72 | 3.5 | Occurrence |
| A1* | | | | | | | |
| Example | 0.25 | 6.8 | 2740 | 0.00 | 2.66 | 4.4 | Occurrence |
| A2* | | | | | | | |
| Example | 0.5 | 14.2 | 2660 | 0.00 | 1.88 | 5.7 | Non- |
| A3 | | | | | | | occurrence |
| Example | 10 | 287 | 2140 | 0.00 | 1.05 | 17.2 | Non- |
| A4 | | | | | | | occurrence |
| Example | 14 | 405 | 1120 | 0.00 | 0.43 | 18.1 | Occurrence |
| A5* | | | | | | | |
| Example | 17 | 521 | 530 | 0.00 | 0.14 | 18.7 | Occurrence |
| A6* | | | | | | | |

*The symbol denotes Comparative Example.

### Examples B1 to B6

LDH separators comprising a Mg—(Al, Ti)-LDH were fabricated and evaluated as follows.

### (1) Preparation of Polymer Porous Substrate

A commercially available polyethylene microporous membrane having a porosity of 50%, an average pore diameter of 0.1 μm, and a thickness of 10 μm was prepared as a polymer porous substrate and cut out to a size of 5.0 cm×5.0 cm.

### (2) Primer Treatment of Polymer Porous Substrate

The substrate prepared in (1) above was coated with a binder solution containing a modified polyolefin resin (AUROREN® AE-202, manufactured by Nippon Paper Industries Co., Ltd.) in the concentration shown in Table 2 by dip coating. The dip coating was carried out by immersing the substrate in 100 ml of the binder solution and then pulling it up vertically. The dip-coated substrate was then dried at room temperature for 1 hour. Thus, a substrate coated with binder resin was obtained. The weight of binder resin adhered with which the porous substrate was coated (per 1 cm³ of porous substrate) is shown in Table 2. The adhered weight was calculated by subtracting the weight W₀ (mg) of the porous substrate before primer treatment from the weight W₁ (mg) of the porous substrate after primer treatment and dividing the result by the volume V (cm³) of the porous substrate (=(W₁−W₀)/V).

### (3) Alumina·Titania Sol Coating on Polymer Porous Substrate

The substrate subjected to primer treatment in (2) above was coated with an amorphous alumina solution (AI-L7, manufactured by Taki Chemical Co., Ltd.) and a titania sol solution (AM-15, manufactured by Taki Chemical Co., Ltd.) by dip coating. The dip liquid was prepared by mixing the amorphous alumina solution and the titania sol solution so that Ti/Al (molar ratio)=2. The dip coating was carried out by immersing the substrate in 100 ml of the sol solution and then pulling it up vertically. Thereafter, the dip-coated substrate was dried at room temperature for 1 hour.

### (4) Preparation of Raw Material Aqueous Solution

Magnesium nitrate hexahydrate (Mg(NO₃)₂·6H₂O, manufactured by Kanto Chemical Co., Inc.) and a urea ((NH₂)₂CO, manufactured by Sigma-Aldrich Co. LLC) were prepared as raw materials. The raw materials were weighed so that the magnesium nitrate hexahydrate was 0.015 mol/L and the urea/NO₃ (molar ratio)=32 and placed in a beaker, and ion-exchanged water was added thereto to have a total volume of 80 ml. Thereafter the mixture was stirred to obtain a raw material aqueous solution.

### (5) Membrane Formation by Hydrothermal Treatment

A Teflon® airtight container (autoclave container having a content of 100 ml and an outer side jacket made of stainless steel), was fed with both the raw material aqueous solution and the substrate dip-coated with the sol solution in (3) above and sealed. At this time, a substrate was fixed while being floated from the bottom of the Teflon® airtight container, and installed vertically so that the solution was in contact with both sides of the substrate. Thereafter, an LDH was formed on a surface and an inside of the substrate by subjecting it to hydrothermal treatment at a hydrothermal temperature of 90° C. for 16 hours. With an elapse of the predetermined time, the substrate was taken out from the airtight container, washed with ion-exchanged water, and dried at room temperature over night to form LDH on a surface of the porous substrate and inside pores thereof. Thus, an LDH separator was obtained.

### (6) Densification by Roll Pressing

The LDH separator was sandwiched between a pair of PET films (Lumiler® manufactured by Toray Industries, Inc., thickness of 40 μm), and roll-pressed at a roll rotation speed of 3 mm/s, a roller heating temperature of 70° ° C., and a roll gap of 70 μm to obtain a further densified LDH separator.

### (6) Various Evaluations

The obtained LDH separators underwent evaluations 1 to 7. The results were as follows.
Evaluation 1: Multiple platy crystals characteristic of LDH were confirmed.
Evaluation 2: As a result of EDS elemental analysis, Mg, Al and Ti that were constituent elements of LDH were detected. That is to say, these elements were confirmed to be incorporated and crystallized as a hydroxide ion-conductive layered compound.
Evaluation 3: In an XRD profile, a peak was detected in the vicinity of 2θ=11.5°, which was identified to be an LDH (hydrotalcites compound). The identification was carried out by using a diffraction peak of the LDH (hydrotalcites compound) described in JCPDS card No. 35-0964.
Evaluation 4: As shown in Table 2, the extremely high denseness such as He permeability of 0.00 cm/min·atm was confirmed. The He permeability of the porous substrate after the primer treatment was also shown in Table 2.
Evaluation 5: As shown in Table 2, the higher ionic conductivity (1.0 mS/cm or more) was confirmed in Examples B1 to B4 than that in Examples B5 and B6 (Comparative Examples).
Evaluation 6: As shown in Table 2, the excellent cycle durability performance (dendrite resistance) was confirmed in Examples B3 and B4, such that no short circuits due to zinc dendrites occurred even after 200 cycles. In Examples B1, B2, B5, and B6 (Comparative Examples), on the other hand, the short circuits due to zinc dendrites occurred after less than 200 cycles, which indicated that the poor cycle durability performance resulted.
Evaluation 7: In Examples B3 to B6, the higher adhesion force (5.0 mN or more) was confirmed than that in Examples B1 and B2 (Comparative Examples).

TABLE 2

| | | | | | | | Cycle |
|---|---|---|---|---|---|---|---|
| | | | | | | | characteristics |
| | | | | | | | Short circuit at |
| | Primer treatment | | | After synthesis | | | 200 cycles |
| | Binder | Adhered | He | He | Ionic | Adhesion | (Occurrence |
| | concentration | weight | permeability | permeability | conductivity | force | or non- |
| Mg-Al, Ti | (wt %) | (mg/cm³) | (cm/min · atm) | (cm/min · atm) | (mS/cm) | (mN) | occurrence) |
| Example | 0 | 0 | 2950 | 0.00 | 3.03 | 3.5 | Occurrence |
| B1* | | | | | | | |
| Example | 0.25 | 6.8 | 2740 | 0.00 | 2.97 | 3.9 | Occurrence |
| B2* | | | | | | | |
| Example | 0.5 | 14.2 | 2660 | 0.00 | 2.66 | 5.1 | Non- |
| B3 | | | | | | | occurrence |
| Example | 10 | 287 | 2140 | 0.00 | 1.22 | 17.8 | Non- |
| B4 | | | | | | | occurrence |
| Example | 14 | 405 | 1120 | 0.00 | 0.60 | 18.6 | Occurrence |
| B5* | | | | | | | |
| Example | 17 | 521 | 530 | 0.00 | 0.38 | 17.7 | Occurrence |
| B6* | | | | | | | |

*The symbol denotes Comparative Example.

### Examples C1 to C9

LDH separators comprising a Mg—(Al,Ti,Y)-LDH-like compound were fabricated and evaluated as follows.

### (1) Preparation of Polymer Porous Substrate

A commercially available polyethylene microporous membrane having a porosity of 50%, an average pore diameter of 0.1 μm, and a thickness of 10 μm was prepared as a polymer porous substrate and cut out to a size of 5.0 cm×5.0 cm.

### (2) Primer Treatment of Polymer Porous Substrate

The substrate prepared in (1) above was coated with a binder solution containing a modified polyolefin resin (AUROREN® AE-202, manufactured by Nippon Paper Industries Co., Ltd.) in the concentration shown in Table 3 by dip coating. The dip coating was carried out by immersing the substrate in 100 ml of the binder solution and then pulling it up vertically. The dip-coated substrate was then dried at room temperature for 1 hour. Thus, a substrate coated with binder resin was obtained. The weight of binder resin adhered with which the porous substrate was coated (per 1 cm³ of porous substrate) is shown in Table 3. The adhered weight was calculated by subtracting the weight W₀ (mg) of the porous substrate before primer treatment from the weight W₁ (mg) of the porous substrate after primer treatment and dividing the result by the volume V (cm³) of the porous substrate (=(W₁−W₀)/V).

### (3) Alumina·Titania·Yttria Sol Coating on Polymer Porous Substrate

The substrate subjected to primer treatment in (2) above was coated with an amorphous alumina solution (Al-L7, manufactured by Taki Chemical Co., Ltd.), a titania solution (AM-15, manufactured by Taki Chemical Co., Ltd.), and yttria sol by dip coating. The dip liquid was prepared by mixing the amorphous alumina solution, the titania solution, and the yttria sol so that the Ti/(Y+Al) (molar ratio)=2 and the Y/Al (molar ratio)=8. The dip coating was carried out by immersing the substrate in 100 ml of the sol solution and then pulling it up vertically. Thereafter, the dip-coated substrate was dried at room temperature for 1 hour.

### (4) Preparation of Raw Material Aqueous Solution

Magnesium nitrate hexahydrate (Mg(NO₃)₂·6H₂O, manufactured by Kanto Chemical Co., Inc.) and urea ((NH₂)₂CO, manufactured by Sigma-Aldrich Co. LLC) were prepared as raw materials. The raw materials were weighed so that the magnesium nitrate hexahydrate was 0.0075 mol/L and urea/NO₃ (molar ratio)=96 and placed in a beaker, and ion-exchanged water was added thereto to have a total volume of 80 ml. Thereafter the mixture was stirred to obtain a raw material aqueous solution.

### (5) Membrane Formation by Hydrothermal Treatment

A Teflon® airtight container (autoclave container having a content of 100 ml and an outer side jacket made of stainless steel) was fed with both the raw material aqueous solution and the substrate dip-coated with the sol solution in (3) above and sealed. At this time, a substrate was fixed while being floated from the bottom of the Teflon® airtight container, and installed vertically so that the solution was in contact with both sides of the substrate. Thereafter, an LDH-like compound was formed on the surface and the inside of the substrate by subjecting it to hydrothermal treatment at a hydrothermal temperature of 120° C. for 16 hours. With an elapse of the predetermined time, the substrate was taken out from the airtight container, washed with ion-exchanged water, and dried at room temperature over night to form an LDH-like compound on a surface of the porous substrate and inside pores thereof. Thus, an LDH separator was obtained.

### (6) Densification by Roll Pressing

The LDH separator was sandwiched between a pair of PET films (Lumiler® manufactured by Toray Industries, Inc., thickness of 40 μm), and roll-pressed at a roll rotation speed of 3 mm/s, a roller heating temperature of 70° C., and a roll gap of 70 μm to obtain a further densified LDH separator.

### (7) Various Evaluations

The obtained LDH separators underwent evaluations 1 to 7. The results were as follows.
Evaluation 1: A large number of platy shapes peculiar to LDH were confirmed.
Evaluation 2: As a result of EDS elemental analysis, Mg, Al, Ti and Y that were constituent elements of LDH-like compound, were detected. That is to say, these elements were confirmed to be incorporated and crystallized as a hydroxide ion-conductive layered compound.
Evaluation 3: In an XRD profile, a peak derived from the LDH-like compound was detected in the range of 5°≤2θ≤10°. Since the (003) peak position of LDH is usually observed at 2θ=11 to 12°, the above peak is considered to be a peak such that the (003) peak of LDH was shifted to the lower angle side, which therefore indicates that the above peak is derived from a compound that is analogous to an LDH although cannot be called LDH (i.e., an LDH-like compound).
Evaluation 4: As shown in Table 3, the extremely high denseness such as a He permeability of 0.00 cm/min·atm, was confirmed. Note, Table 3 also shows the He permeability of the porous substrate after primer treatment.
Evaluation 5: As shown in Table 3, the higher ionic conductivity (1.0 mS/cm or more) was confirmed in Examples C1 to C6 than that in Examples C7 to C9 (Comparative Examples).
Evaluation 6: As shown in Table 3, the excellent dendrite resistance such that no short circuits occurred due to zinc dendrites even after 400 cycles, was confirmed in Examples C3 to C6. In Examples C1, C2, and C7 to C9 (Comparative Examples), on the other hand, the short circuits due to zinc dendrites occurred after less than 400 cycles, which indicated that the poor dendrite resistance resulted.
Evaluation 7: In Examples C3 to C9, the higher adhesion force (5.0 mN or more) was confirmed than that in Examples C1 and C2 (Comparative Examples).

TABLE 3

| | | | | | | | Cycle |
|---|---|---|---|---|---|---|---|
| | | | | | | | characteristics |
| | | | | | | | Short circuit at |
| | Primer treatment | | | After synthesis | | | 400 cycles |
| | Binder | Adhered | He | He | Ionic | Adhesion | (Occurrence |
| Mg- | concentration | weight | permeability | permeability | conductivity | force | or non- |
| Al, Ti, Y | (wt %) | (mg/cm³) | (cm/min · atm) | (cm/min · atm) | (mS/cm) | (mN) | occurrence) |
| Example | 0 | 0 | 2950 | 0.00 | 3.55 | 3.6 | Occurrence |
| C1* | | | | | | | |
| Example | 0.25 | 6.8 | 2740 | 0.00 | 3.32 | 4.3 | Occurrence |
| C2* | | | | | | | |
| Example | 0.5 | 14.2 | 2660 | 0.00 | 3.02 | 5.2 | Non- |
| C3 | | | | | | | occurrence |
| Example | 1 | 30.6 | 2510 | 0.00 | 2.81 | 8.3 | Non- |
| C4 | | | | | | | occurrence |
| Example | 5 | 144 | 2440 | 0.00 | 2.38 | 14.7 | Non- |
| C5 | | | | | | | occurrence |
| Example | 10 | 287 | 2140 | 0.00 | 1.77 | 18.5 | Non- |
| C6 | | | | | | | occurrence |
| Example | 14 | 405 | 1120 | 0.00 | 0.70 | 19.2 | Occurrence |
| C7* | | | | | | | |
| Example | 17 | 521 | 530 | 0.00 | 0.44 | 18.5 | Occurrence |
| C8* | | | | | | | |
| Example | 20 | 594 | 380 | 0.00 | 0.29 | 19.2 | Occurrence |
| C9* | | | | | | | |

*The symbol denotes Comparative Example.

What is claimed is:

1. An LDH separator comprising:
a porous substrate; and
a surface layer provided on at least one surface of the porous substrate and comprising a hydroxide ion-conductive layered compound that is a layered double hydroxide (LDH) and/or a layered double hydroxide (LDH)-like compound;
wherein the LDH separator has an ionic conductivity of 1.0 mS/cm or more, and an adhesion force of 5.0 mN or more between the surface layer and the porous substrate, and
the adhesion force is a critical load value measured by subjecting a surface including the surface layer of the LDH separator to a micro-scratch test in accordance with JIS R3255-1997 under the conditions of a scratch rate of 10 μm/s, a tip curvature radius of a diamond indenter needle of 25 μm, a load application rate of 30 mN/min, an excitation amplitude of 50 μm, and an excitation frequency of 45 Hz.

2. The LDH separator according to claim 1, wherein the hydroxide ion-conductive layered compound fills up pores of the porous substrate.

3. The LDH separator according to claim 1, wherein the hydroxide ion-conductive layered compound is an LDH-like compound, and the LDH-like compound comprises (i) Mg and (ii) one or more elements comprising at least Ti, selected from the group consisting of Ti, Y and Al.

4. The LDH separator according to claim 1, wherein the hydroxide ion-conductive layered compound is an LDH, and the LDH is composed of a plurality of hydroxide base layers comprising Mg, Al and OH groups, and interlayers composed of anions and H₂O interposed between the plurality of hydroxide base layers.

5. The LDH separator according to claim 4, wherein the plurality of hydroxide base layers further comprise Ti.

6. The LDH separator according to claim 1, wherein the surface layer has a thickness of from 0.01 to 10 μm.

7. The LDH separator according to claim 1, wherein the LDH separator has a thickness of from 3 to 80 μm.

8. The LDH separator according to claim 1, wherein the porous substrate is composed of a polymer material.

9. The LDH separator according to claim 1, wherein the LDH separator has a He permeability per unit area of 10 cm/min·atm or less.

10. The LDH separator according to claim 1, wherein the LDH separator has been pressed in a thickness direction of the LDH separator.

11. The LDH separator according to claim 1, wherein the surface layer is free of a binder resin.

12. A method for producing an LDH separator, comprising:
covering at least one surface of a porous substrate with a binder resin, and
subjecting the porous substrate covered with the binder resin to hydrothermal treatment in a raw material aqueous solution comprising a constituent element of a hydroxide ion-conductive layered compound that is a layered double hydroxide (LDH) and/or a layered double hydroxide (LDH)-like compound to form a surface layer comprising the hydroxide ion-conductive layered compound on a surface of the porous substrate comprising the binder resin.

13. The method for producing the LDH separator according to claim 12, wherein covering the porous substrate with the binder resin comprises coating a surface of the porous substrate with a solution dissolving the binder resin.

14. A zinc secondary battery comprising the LDH separator according to claim 1.

15. A solid alkaline fuel cell comprising the LDH separator according to claim 1.
